(19) United States
(12) Patent Application Publication
(10) Pub. No.: US 2025/0252256 A1
(43) Pub. Date: Aug. 7, 2025

(54) MACHINE LEARNING DOCUMENT PARSER

(71) Applicant: BOLD Limited, Hamilton (BM)

(72) Inventor: Rohit GARG, Ghaziabad (IN)

(21) Appl. No.: 18/434,675

(22) Filed: Feb. 6, 2024

(51) Int. Cl. G06N 3/0455; G06F 40/174; G06F 40/205

(52) U.S. Cl. CPC G06F 40/205; G06F 40/174

(57) ABSTRACT

Certain aspects of the disclosure provide systems and methods for parsing documents using machine learning. For example, a method may include receiving a document of a target document type and in a target human language. The method may include parsing the document with a specialized large language model (LLM) focused on parsing only the target document type in the target human language. The LLM may be trained using a set of training documents of the target document type. Each training document may be a résumé downloaded at least once, and has a completion score equal or greater than a threshold value. The method may include generating parsed content of the document including content extracted from the document. The method may include populating a plurality of predefined fields with the parsed content of the document. The method may include outputting the populated predefined fields to an output device.

### BACKGROUND

### Field

Aspects of the present disclosure relate to document parsing, and more particularly to document parsing using machine learning.

### Description of Related Art

Often digital documents need to be parsed to facilitate the extraction of information and matching the information to fields in a database, for example. However, parsing systems can be prone to mistakes where information is matched to incorrect fields. Recently, with the development of machine learning, the matching process has improved. However, limitations still exist. For example, while many machine learning based parsing systems are reasonable accurate parsing documents written in English, these same parsing systems are woefully inaccurate when parsing documents written in non-English languages.

Use of general purpose large language models (LLMs) in parsing systems can increase accuracy when parsing documents in non-English languages. However, general purpose LLMs, such as ChatGPT-3 and similar, are massive and require significant computational resources to fine tune for such tasks. Moreover, because of their size, these general purpose LLMs require more time to parse a document than simpler machine learning-based parsing systems. Also, general purpose LLMs can be prone to hallucinations, which can completely undermine the tasks they are supporting.

Consequently, a need exists for document parsing methods and systems that can accurately parse documents written in a variety of languages in a timely fashion and with limited resources.

### SUMMARY

In one general aspect, a method may include receiving a document of a target document type and in a target human language. The method may also include parsing, using a large language model (LLM), the document, where the LLM is a specialized LLM focused on parsing only the target document type in the target human language, the LLM having been trained using a set of training documents of the target document type, where each training document of the set of training documents is a résumé that has been downloaded at least once by an user, and has a completion score equal or greater than a threshold value. The method may furthermore include generating parsed content of the document including content extracted from the document. The method may in addition include populating a plurality of predefined fields with the parsed content of the document. The method may moreover include outputting the populated predefined fields to an output device.

In one general aspect, a system may include a memory. The system may also include one or more storage devices storing computer-readable instructions. The system may furthermore include one or more processors configured, when executing the computer-readable instructions, to: receive a document of a target document type and in a target human language; parse the document using a large language model (LLM), where the LLM is a specialized LLM focused on parsing only the target document type in the target human language, the LLM having been trained using a set of training documents of the target document type, where each training document of the set of training is a résumé that has been downloaded at least once by an user, and has a completion score equal or greater than a threshold value; generate parsed content of the document including content extracted from the document; populate a plurality of predefined fields with the parsed content of the document; and output the populated predefined fields to an output device.

In one general aspect, a method may include adapting an LLM to operate on a local host with reduced resources. The method may also include curating a plurality of résumé documents in a target human language, the plurality of résumés documents meeting or exceeding a completion threshold of at least 0.80 and have been downloaded at least once. The method may furthermore include converting the plurality of résumé documents into converted documents having a data interchange format including field/value pairs, the fields being predefined fields and the values being extracted from the plurality of documents. The method may in addition include separating the converted documents into a set of training data and a set of test data, the set of training data being larger than the set of test data, wherein the training data is used to obtain a specialized LLM focused on only parsing résumé documents of the target human language. The method may moreover include adjusting parameters of the LLM based on the training data. The method may also include testing the LLM using the set of test data. The method may furthermore include outputting the LLM as the specialized LLM once a testing result of the testing of the LLM exceeds a success threshold, where adjusting and testing are repeated until the testing exceeds the success threshold

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for parsing documents in accordance with aspects of the present disclosure.

FIG. 2 depicts an example method for processing documents in accordance with aspects of the present disclosure.

FIG. 3 depicts an example method for training a specialized large language model for processing documents in accordance with aspects of the present disclosure.

FIG. 4 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for parsing documents.

Conventionally, résumés, tax returns, mortgage applications, etc. would have been submitted in hardcopy (i.e., paper) form and entered into a computer system by an individual. However, with the increased submission of these documents digitally via online portals, the task of translating the information on the document into values assigned to specific data fields has fallen to automated parsing systems and software. Conventionally, these document parsing systems utilize various techniques to match terms encountered in a document with keywords stored in a database. For standardized documents, such as mortgage applications, the document parsing systems, may perform quite well, with a high level of accuracy matching user-provided information (e.g., values) with appropriate database fields. However, for more free-form/less-structured documents, such as résumés, which do not have standardized terminology and structure, conventional document parsing systems can be quite inaccurate with matching values with the appropriate fields. For example, document parsing systems may have issues identifying job titles or addresses, especially if the document is written in a language other than English-doubly so if the language uses a non-Latin writing system, such as Cyrillic, Kanji, or the like.

Systems and methods described herein leverage large language models (LLMs) to enhance document parsing accuracy, including for non-English languages, where conventional document parsing systems are particularly inaccurate. A number of LLMs are suitable for implementing aspects of the present disclosure, such as Flan-T5, GPT, Chinchilla, PaLM, BLOOM, GPT-Neo, or other LLMs capable of being trained for specialized language generation applications. However, LLM document parsing can have several drawbacks, namely hallucinations and slower parsing speed than conventional systems. In order to overcome these deficiencies of typical LLMs, aspects of the present disclosure rely on a specialized LLM that has been specifically fine-tuned to parse documents of a limited number of document types and in a single language, for example, résumés and curricula vitae, prepared in a human language, such as Spanish. By training and applying a specialized LLM to the task of parsing résumés, for example, hallucinations can be essentially eliminated. Moreover, a specialized LLM need not have the enormous number of trainable parameters (e.g., 175 billion parameters common in generalized LLMs). Instead, smaller specialized LLMs, for example, with 780 million parameters, can be used without sacrificing accuracy.

In general-purpose LLM models, more parameters generally equates with increased accuracy, although at the cost of increased processing time and resources. However, focusing a specialized LLM with fewer parameters to a specific task, e.g., only parsing résumés and curricula vitae written in a particular language, can yield comparable accuracy with beneficially reduced processing time and resources. Moreover, since the specialized LLM is focused on a specific task, there may also a beneficially reduced occurrence of hallucinations.

As a further benefit, the model architectures described herein are compact enough to be implemented on a local host system, such as a server or even a desktop computer system with relatively limited resources. However, the model architectures described herein are equally capable of being deployed on networked servers or in cloud-based environments with a concomitant increase in performance. In comparison, larger generalized LLMs are proprietary and rely on the massive computational power, memory, and storage capacity available with a distributed cloud infrastructure.

For example large generalized LLMs with upwards of 175 billion parameters may require a minimum of 700 GB of random access memory (RAM) just to support the parameters, which are expressed in Float32 (single precision floating point, i.e., IEEE 754). In contrast, the specialized LLM used in the present disclosure, can accommodate its 780 million parameters in as little as 3.05 GB. In both cases additional RAM is still needed for the LLM to perform its various functions and calculation, as well.

In addition to utilizing LLMs with a lower parameter count, embodiments of the present disclosure may convert the parameters from Float32 to Int8 (8-bit integer numerical representation). The specialized LLM in the above example, which uses Float32 to express parameters, may require 40 GB of RAM to properly function. On the other hand, by converting the parameters to Int8, the same LLM may require as little as 1 GB of RAM to accommodate the 780 million parameters, thus the Int8 version of the LLM can function with 10 GB of RAM. Consequently, embodiments of the present disclosure can be implemented in a typical processing system equipped with 16 GB of RAM.

While using Int8 instead of Float32 to represent the parameter values reduces overall memory requirements of the LLM, this advantage does come with a trade-off, namely the Int8-based LLM may be less accurate than the Float32-based LLM. However, by selecting high quality sample data for training the LLM, such résumés that have been downloaded at least once by a user, and have a completion score equal or greater than a threshold value of 0.80 (e.g., 80% completion) for example, the Int8-based LLM can approach the accuracy of the Float32-based LLM.

In accordance with aspects of the present disclosure, systems and methods described herein below implement a light-weight LLM. Additionally, the light-weight LLM may be configured and fine-tuned to function solely as a dedicated document parsing engine for a single document type (e.g., résumés/curricula vitae) written in a single human language. Further, the light-weight LLM may be configured and trained to output the parsed values in a format tailored to the particular needs of an organization or individual implementing the below-described systems and methods.

For the purposes of clarity and brevity, aspects of the disclosure will be describe, throughout, with respect to résumés and curricula vitae. However, aspects of the present disclosure are equally applicable to other document types, such as mortgage applications, college/university entrance applications, and the like.

### Example System

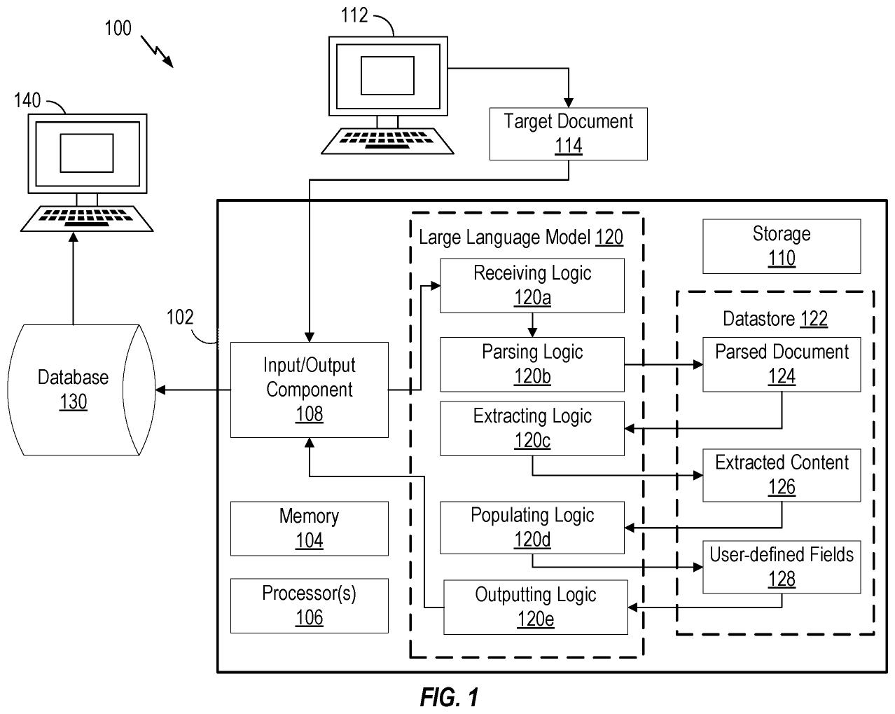

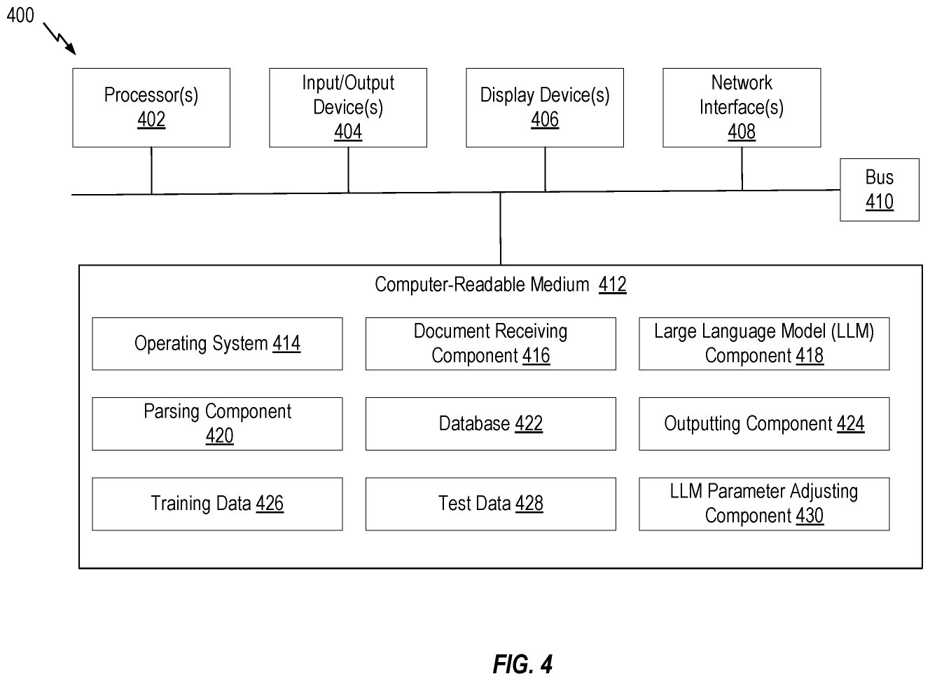

FIG. 1 depicts an example system 100 implementing aspects of the present disclosure. The system 100, includes a host computer 102, such as a server indicative of a processing system such as system 400 in FIG. 4. The host computer 102 also includes one or more processors 106, which may be any of microcontrollers, central processing units (CPUs), graphical processing units (GPUs), specifically-configured field programmable gate arrays (FPGAs), or combinations thereof. However, for conciseness and clarity in describing aspects of the disclosure, the different types of processors are referenced collectively, and without any explicit or implied limitation, as processors 106 or processor 106.

It is understood that when one processor 106 is present, all the computations and functions attributed to the processors 106 are performed by the one processor 106. However, in embodiments where multiple processors 106 are present, all the described computations and functions ascribed to the processors 106 may be performed by each processor 106. Alternatively, the described computations and functions ascribed to the processors 106 may be performed by the multiple processors 106 as a whole, such that individual processors 106 may perform individual calculations and/or functions.

The host computer 102 may include one or more storage devices. For example, the system 100 is shown with a storage device 110 and a datastore 122. The datastore 122 may be implemented in a separate storage or may be implemented in a portion (e.g., partition) of the storage device 110. Additionally the storage device 110 and datastore 122 may be implemented by one or more mass storage devices, such as magnetic disk drives, solid-state drives, optical drives, or combinations of these devices. The mass storage devices may be configured in any of the standard redundant array of independent disks (RAID) configurations, or as one logical volume, e.g., just-a-bunch-of-disks (JBOD configuration). In some embodiments, the storage device 110 and datastore 122 may be separate RAID or JBOD volumes.

The host computer 102 provides an input/output (I/O) component 108, which may include hardware implementing one or more: network interfaces (e.g., IEEE 802.11, IEEE 802.3, etc.), universal system bus (USB), FireWire (IEEE 1394), HDMI (ANSI/CTA-861), and/or other I/O interfaces. The I/O component 108 provides interfaces for connecting a keyboard and pointing devices directly to the host computer 102. Additionally, the I/O component 108 provides an interface for receiving target documents 114 via the Internet from external sources, such as remote computers 112. Remote computers 112 may include laptop computers, desktop computers, and mobile devices, such as smartphones and tablets.

It is understood that the host computer 102 described with respect to system 100 may, alternatively, be implemented as cloud services, distributed servers, or the like, without deviating from the scope of the present disclosure.

A large language model (LLM) 120 is installed on the host computer 102. The processor 106 executes the functions and calculations, defined by computer-readable instructions stored on the storage device 110, of the LLM 120. For example, the LLM 120 includes receiving logic 120a configured to receive target documents 114 from the remote computer 112 via the I/O component 108. Since the LLM in the present disclosure has a singular focus—the LLM has been trained using a set of training documents of the target document type, (e.g., résumés and curricula vitae), in which each document has been downloaded at least once by a user, and has a completion score equal or greater than a threshold value—a detailed prompt is not needed. Accordingly, implementations of aspects of the present disclosure have the résumé as an input; the output is automatic generated in the desired format based on the training. The target document 114 is a document of a target document type (e.g., résumé) and in a target human language (e.g., Spanish). The target documents 114 may be provided in any one or more appropriate standard document formats, such as DOCX, plain text (.txt) or portable document format (PDF), and the like.

Additionally, the LLM 120 includes parsing logic 120b configured to parse the target document 114. The parsed document 124 may be stored in the datastore 122. Extracting logic 120c is configured to generate parsed content of the target document 114 that includes content extracted from the parsed document 124. The extracted content 126 may be stored in the datastore 122.

Populating logic 120d is configured to access the extracted content 126 and populate a plurality of predefined fields (e.g., user-defined fields 128 of a database record) with the extracted content 126. Outputting logic 120e is configured to output the populated predefined fields 128 to an output device via the I/O component 108. The output device may be a storage device containing a database 130, which may be accessed by a third party computer 140. The third party computer 140, may embody a résumé submission service, employment agency or an employer's computer. The parsed résumé data is available in the format specified during training. The end consumer (résumé submission service, employment agency or an employer) may then apply its own converter to consume the generated data and make it suitable to display.

In embodiments where the target document type is a college/university admissions application, the third party computer 140 may be a university admissions department system. In embodiments where the target document type is a mortgage application, the third party computer 140 may be a bank or financial institution's mortgage department system. Accordingly, it is understood that, in the context of, and without deviating from, aspects of the present disclosure, the third party computer 140 is intended to encompass any appropriate receiver of the target document type.

In certain embodiments of the system 100, multiple LLMs 120 may be installed on the host computer 102. In such a configuration, each LLM 120 may be fine-tuned and dedicated to processing a different language. For example, a first LLM 120 may be configured to process résumés written in Spanish, while a second LLM 120 may be configured to process résumés written in Chinese, and yet another LLM 120 may be configured for Japanese. A frontend component (not shown) may be implemented to provide automatic detection of the document language, and routing of the target document 114 to the appropriate LLM 120. Alternatively, the interface presented to a user for submitting the document (e.g., résumé) may include a user interface (UI) element, such as a dropdown menu, configured to allow the user to manually select the appropriate language. The language selection may be used by the system 100 to direct the submitted target document 114 to the appropriate LLM 120.

### Example Method for Parsing a Document

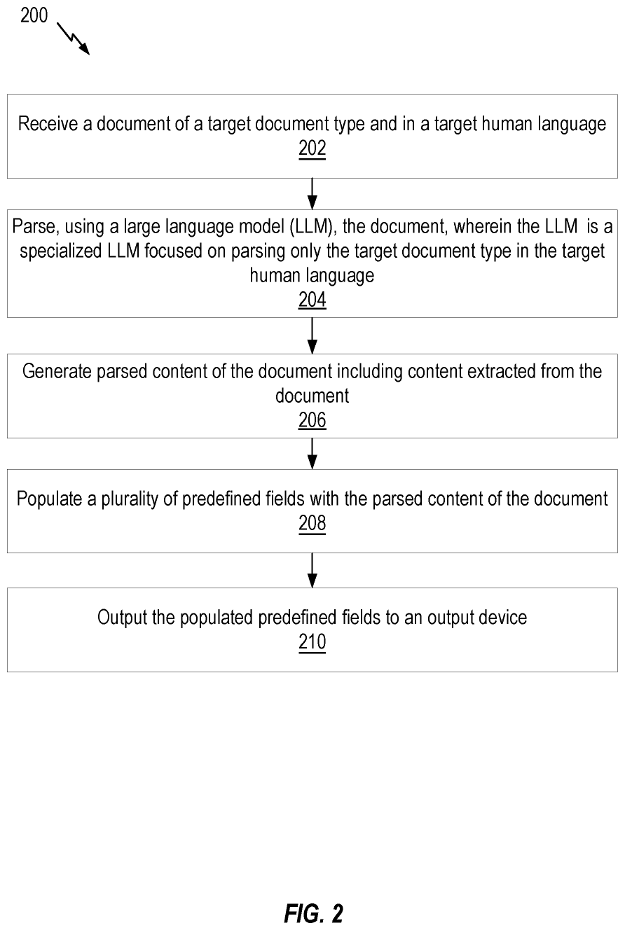

FIG. 2 depicts a method 200 for parsing a document (e.g., target document 114 of FIG. 1) of a target document type written in a target human language. The method 200, initially, causes a host computer (e.g., host computer 102 in FIG. 1), for example, to receive a document 114 of a target document type (e.g., résumés) and written in a target human language at 202.

At 204, the method 200 causes the host computer 102, for example, to parse the document 114 using an LLM (e.g., LLM 120 of FIG. 1). The LLM 120 is a specialized LLM focused on parsing only the target document type in the target human language. The method 200 may cause the host computer 102 to generate a temporary document (e.g., parsed document 124 of FIG. 1).

At 206, the method 200 causes the host computer 102, for example, to generate parsed content of the document including content extracted from the document 114 (e.g., extracted content 126 of FIG. 1).

At 208, the method 200 causes the host computer 102, for example, to populate a plurality of predefined fields (e.g., user-defined fields 128 of FIG. 1) with the parsed content of the document (e.g., extracted content 126).

At 210, the method 200 causes the host computer 102, for example, to output the populated predefined fields 128 to an output device, such as database 130 of FIG. 1.

### Example Method for Training a Specialized LLM Focused on Parsing Specific Document Types

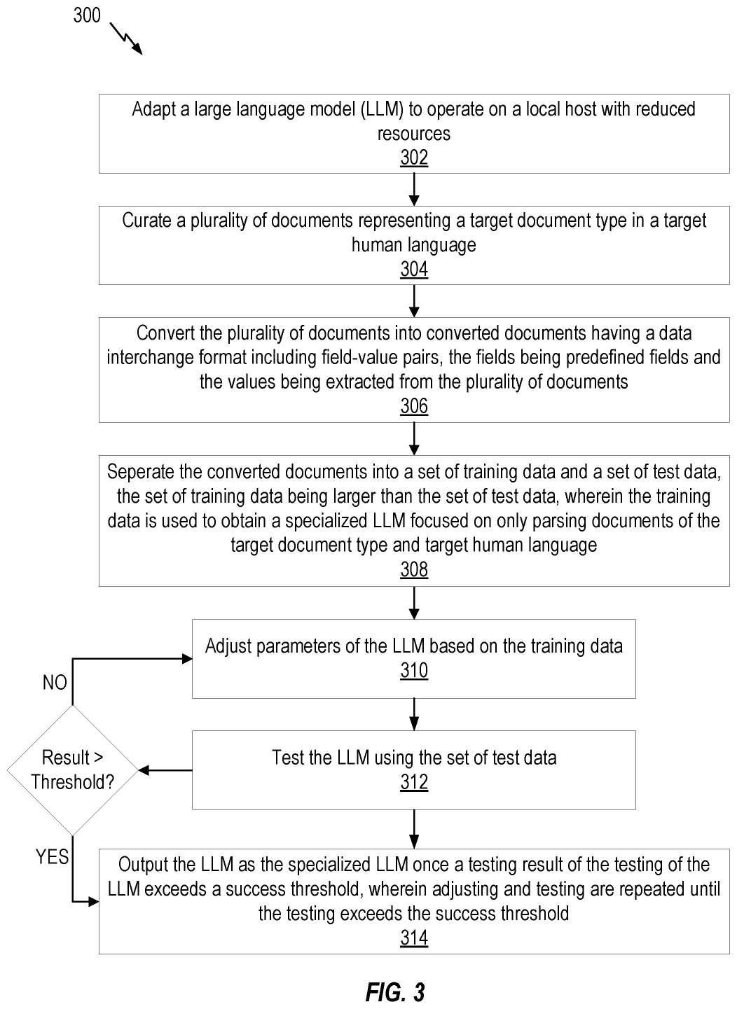

FIG. 3 depicts a method 300 for training a specialized LLM (e.g., LLM 120 in FIG. 1) focused on parsing documents (e.g., target document 114 of FIG. 1) of a target document type written in a target human language.

At 302, the method 300 causes a system (e.g., host computer 102 in FIG. 1) to adapt a LLM to operate on the host computer 102 with reduced resources. As described above with respect to FIG. 1, the host computer 102 may be, for example, a server equipped with a limited amount of processing bandwidth, memory (e.g., memory 104 in FIG. 1) and storage (e.g., storage device 110 in FIG. 1). Aspects of the present disclosure can run on machine with 16 GB of RAM or a GPU with 16 GB memory. In practice the resource requirements of the system depends on the throughput requirements. The LLM used is constrained by the available resources. Thus, as described above, in some embodiments of the present disclosure the parameters of the LLM may be converted from Float32 values to Int8 values, which can reduce the amount of memory required by as much as 75%. Consequently, the LLM can be executed on a system having as little as 16 GB of RAM.

In systems that have more available memory, the LLM parameters may be converted from Float32 to Int16 instead, resulting in a 50% reduction in memory required and lower reduction in accuracy over the Int8 parameters. Moreover, aspects of the present disclosure can be advantageously applied to LLM models installed as cloud services or on large datacenters as well.

At 304, the method 300 causes the host computer 102 to collect a plurality of documents 114 representing a target document type (e.g., résumés) in a target human language (e.g., Spanish, Chinese, etc.). The plurality of documents are selected based on quality.

For example, in the case of a résumé parsing system, the documents selected may be résumés that have been completed or have been nearly completed. Completion in this case may be considered as including information entered in a defined number of different sections (e.g., name, address, current position, current company name, etc.) constituting a résumé. A résumé having none of these sections filled may be assigned a rating of zero, while a résumé with all of the defined sections filled may be assigned a rating of 1. A threshold rating value meets or exceeds 0.80 (e.g., 80% completion) may be used for selecting high quality résumés as the plurality of documents 114. In addition to meeting the 0.8 threshold value, résumés may need to meet other quality metrics, such as having been downloaded at least once. According to some embodiments the threshold value may be lower, such as 0.5, while in other embodiments it may be higher, such as 0.9. The LLM according to aspects of the present disclosure is intended for specialized, focused tasks, namely parsing a target document type, e.g., résumés and the like, in a single target language, thus, the number of training data required may be reduced in comparison to the training needs for a generalized LLM. Thus, in some embodiments, one thousand high quality documents are selected, but, more or less documents, e.g., 750-3000 documents, or more, may be selected depending on the requirements and limitations of a particular implementation. However, there is a lower limit, e.g., 750 documents, regarding the number of documents used for training the AI model, below which the number of documents is insufficient to adequately train the AI model. The lower limit may depend on the particular LLM being used and the threshold accuracy tolerance, since a smaller test dataset will lower the accuracy of the output from the LLM.

At 306, the method 300 causes the host computer 102 to convert the plurality of documents 114 into converted documents having a data interchange format including field/value pairs. The fields may be user-defined fields, and the values may be extracted from the plurality of documents 114. The data interchange format may be any format having a field/value structure, such as JavaScript Object Notation (JSON), extensible markup language (XML), and the like.

At 308, the method 300 causes the host computer 102 to separate the converted documents into a set of training data and a set of test data. The set of training data may be larger than the set of test data. The training data is used to obtain a specialized LLM 120 focused on only parsing documents 114 of the target document type and target human language.

At 310, the method 300 causes the host computer 102 to adjust parameters of the LLM based on the training data. Based on extensive experimentation and evaluation using output metrics specifically designed for developing the present disclosure, it has been found that embodiments of the present disclosure demonstrate an optimal increase in accuracy when the top three to five layers are fine-tuned. Fine-tuning more than the top five layers of the LLM model will see significantly smaller incremental increases in accuracy or none at all, with a concomitant increase in training time.

At 312, the method 300 causes the host computer 102 to test the LLM using the set of test data.

At 314, the method 300 causes the host computer 102 to output the LLM as the specialized LLM 120 once a testing result of the testing of the LLM exceeds a success threshold. The method 300 causes the host computer 102 to repeat 310 and 312 until the testing exceeds the success threshold.

### Example Processing System for Parsing a Document

FIG. 4 depicts an example processing system 400 configured to perform various aspects described herein, including, for example, method 200, as described above with respect to FIG. 2, and method 300, as described above with respect to FIG. 3.

Processing system 400 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 400 includes one or more processors 402, one or more input/output devices 404, one or more display devices 406, and one or more network interfaces 408 through which processing system 400 is connected to one or more networks (e.g., a local network, an intranet, the Internet, or any other group of processing systems communicatively connected to each other), and computer-readable medium 412.

In the depicted example, the aforementioned components are coupled by a bus 410, which may generally be configured for data and/or power exchange amongst the components. Bus 410 may be representative of multiple buses, while only one is depicted for simplicity.

Processor(s) 402 are generally configured to retrieve and execute instructions stored in one or more memories, including local memories like the computer-readable medium 412, as well as remote memories and data stores. Similarly, processor(s) 402 are configured to retrieve and store application data residing in local memories like the computer-readable medium 412, as well as remote memories and data stores. More generally, bus 410 is configured to transmit programming instructions and application data among the processor(s) 402, display device(s) 406, network interface(s) 408, and computer-readable medium 412. In certain embodiments, processor(s) 402 are included to be representative of a one or more central processing units (CPUs), graphics processing unit (GPUs), tensor processing unit (TPUs), accelerators, and other processing devices.

Input/output device(s) 404 may include any device, mechanism, system, interactive display, and/or various other hardware components for communicating information between processing system 400 and a user of processing system 400. For example, input/output device(s) 404 may include input hardware, such as a keyboard, touch screen, button, microphone, and/or other device for receiving inputs from the user. Input/output device(s) 404 may further include display hardware, such as, for example, a monitor, a video card, and/or other another device for sending and/or presenting visual data to the user. In certain embodiments, input/output device(s) 404 is or includes a graphical user interface.

Display device(s) 406 may generally include any sort of device configured to display data, information, graphics, user interface elements, and the like to a user. For example, display device(s) 406 may include internal and external displays such as an internal display of a tablet computer or an external display for a server computer or a projector. Display device(s) 406 may further include displays for devices, such as augmented, virtual, and/or extended reality devices.

Network interface(s) 408 provide processing system 400 with access to external networks and thereby to external processing systems. Network interface(s) 408 can generally be any device capable of transmitting and/or receiving data via a wired or wireless network connection. Accordingly, network interface(s) 408 can include a communication transceiver for sending and/or receiving any wired and/or wireless communication. For example, Network interface(s) 408 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 408 includes hardware configured to operate in accordance with the Bluetooth® wireless communication protocol.

Computer-readable medium 412 may be a volatile memory, such as a random access memory (RAM), or a nonvolatile memory, such as nonvolatile random access memory, phase change random access memory, or the like. In this example, computer-readable medium 412 includes an operating system 414, e.g., Microsoft Windows®, Unix variants, Linux variants, or the like. Additionally, the computer-readable medium 412 includes a document receiving component 416, an LLM component 418, a parsing component 420, a database 422, an outputting component 424, training data 426, test data 428, and an LLM parameter adjusting component 430.

In certain embodiments, the document receiving component 416 is configured to receive documents (e.g., target documents 114 in FIG. 1) of a target document type written in a target human language, as described above with respect to block 202 of FIG. 2. In certain embodiments, the document receiving component 416 is configured to curate a plurality of documents representative of the target document type written in the target human language, as described above with respect to block 304 of FIG. 3.

In certain embodiments, the LLM component 418 is a specialized LLM (e.g., LLM 120 in FIG. 1), trained as described above with respect to FIG. 3. The LLM component 418 receives a target document 114 and parses the document 114 to extract content that is assigned to predefined fields of the database 422, as described with respect to method 200 shown in FIG. 2.

In certain embodiments, the parsing component 420 is a component of the LLM component 418, as shown in FIG. 1, for example. The parsing component 420 receives the document 114 from the document receiving component 416 and parses the document 114 to generate parsed content of the document including content extracted from the document 114, and populate a plurality of predefined fields with the parsed content of the document 114.

In certain embodiments, the outputting component 424 (e.g., outputting logic 120d in FIG. 1) is a component of the LLM component 418, as shown in FIG. 1, for example. The outputting component 424 outputs the populated plurality of predefined fields to the database 422 (e.g., database 130 in FIG. 1). The database 422 can be accessed by third party computers (e.g., computer 140 in FIG. 1) such as a résumé submission service, employment agency or an employer's computer.

In certain embodiments, the training data 426 and the test data 428 are used to train the LLM component 418 as shown in the method 300 of FIG. 3.

Note that FIG. 4 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method for processing a document, the method comprising: receiving a document of a target document type and in a target human language; parsing, using a large language model (LLM), the document, wherein the LLM is a specialized LLM focused on parsing only the target document type in the target human language, the LLM having been trained using a set of training documents of the target document type, where each training document of the set of training documents is a résumé that has been downloaded at least once by a user, and has a completion score equal or greater than a threshold value; generating parsed content of the document including content extracted from the document; populating a plurality of predefined fields with the parsed content of the document; and outputting the populated predefined fields to an output device.

Clause 2: The method of Clause 1, wherein the target document type is a résumé document type, and the résumé document type includes at least one document selected from a group consisting of: a résumé, and a curricula vitae.

Clause 3: The method of Clause 1 or Clause 2, wherein the target human language is any one human language selected from a group consisting of: English, Spanish, French, German, Chinese, and Japanese.

Clause 4: The method of any one of Clauses 1-3, wherein the predefined fields are fields of a database record.

Clause 5: The method of any one of Clauses 1-4, further comprising hosting the LLM on a local computer system.

Clause 6: The method of any one of Clauses 1-5, further comprising configuring the LLM to parse the target document type using reduced system resources, wherein the LLM is configured with parameters modified to use Int8 values.

Clause 7: The method of any one of Clauses 1-6, wherein the threshold value is 0.80 completion, and each training document of the set of training documents is a résumé document that is 80% complete.

Clause 8: A method for training a specialized large language model (LLM) comprising: adapting an LLM to operate on a local host; curating a plurality of résumé documents in a target human language, the plurality of résumés documents meeting or exceeding a completion threshold of at least 0.80 and have been downloaded at least once; converting the plurality of résumé documents into converted documents having a data interchange format including field/value pairs, the fields being predefined fields and the values being extracted from the plurality of documents; separating the converted documents into a set of training data and a set of test data, the set of training data being larger than the set of test data, wherein the training data is used to obtain a specialized LLM focused on only parsing résumé documents of the target human language; adjusting parameters of the LLM based on the training data; testing the LLM using the set of test data; and outputting the LLM as the specialized LLM once a testing result of the testing of the LLM exceeds a success threshold, wherein adjusting and testing are repeated until the testing exceeds the success threshold.

Clause 9: The method of Clause 8, wherein the résumé documents include at least one document selected from a group consisting of: a résumé, and a curricula vitae.

Clause 10: The method of Clause 8 or Clause 9, wherein the target human language is any one human language selected from a group consisting of: English, Spanish, French, German, Chinese, and Japanese.

Clause 11: The method of any one of Clauses 8-10, wherein the parameters receive values converted from Float32 to Int8.

Clause 12: The method of any one of Clauses 8-11, wherein the predefined fields are fields of a database record.

Clause 13: The method of any one of Clauses 8-12, wherein the data interchange format of the converted documents is JavaScript Object Notation (JSON) format.

Clause 14: A processing system, comprising: a memory comprising computer-executable instructions; and a processor configured to execute the computer-executable instructions and cause the processing system to perform a method in accordance with any one of Clauses 1-13.

Clause 15: A processing system, comprising means for performing a method in accordance with any one of Clauses 1-13.

Clause 16: A non-transitory computer-readable medium storing program code for causing a processing system to perform the steps of any one of Clauses 1-13.

Clause 17: A computer program product embodied on a computer-readable storage medium comprising code for performing a method in accordance with any one of Clauses 1-13.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for processing a document, the method comprising:
receiving a document of a target document type and in a target human language;
parsing, using a large language model (LLM), the document, wherein the LLM is a specialized LLM focused on parsing only the target document type in the target human language, the LLM having been trained using a set of training documents of the target document type, where each training document of the set of training documents is a résumé that has been downloaded at least once by a user, and has a completion score equal or greater than a threshold value;
generating parsed content of the document including content extracted from the document;
populating a plurality of predefined fields with the parsed content of the document; and
outputting the populated predefined fields to an output device.

2. The method of claim 1, wherein the target document type is a résumé document type, and the résumé document type includes at least one document selected from a group consisting of: a résumé, and a curricula vitae.

3. The method of claim 1, wherein the target human language is any one human language selected from a group consisting of: English, Spanish, French, German, Chinese, and Japanese.

4. The method of claim 1, wherein the predefined fields are fields of a database record.

5. The method of claim 1, further comprising hosting the LLM on a local computer system.

6. The method of claim 5, further comprising configuring the LLM to parse the target document type using reduced system resources, wherein the LLM is configured with parameters modified to use Int8 values.

7. The method of claim 1, wherein the threshold value is 0.80 completion, and each training document of the set of training documents is a résumé document that is 80% complete.

8. A system for processing a document, the system comprising:
a memory;
one or more storage devices storing computer-readable instructions;
one or more processors configured, when executing the computer-readable instructions, to:
receive a document of a target document type and in a target human language;
parse the document using a large language model (LLM), wherein the LLM is a specialized LLM focused on parsing only the target document type in the target human language, the LLM having been trained using a set of training documents of the target document type, where each training document of the set of training is a résumé that has been downloaded at least once by a user, and has a completion score equal or greater than a threshold value;
generate parsed content of the document including content extracted from the document;
populate a plurality of predefined fields with the parsed content of the document; and
output the populated predefined fields to an output device.

9. The system of claim 8, wherein the target document type is a résumé document type, and the résumé document type includes at least one document selected from a group consisting of: a résumé, and a curricula vitae.

10. The system of claim 8, wherein the target human language is any one human language selected from a group consisting of: English, Spanish, French, German, Chinese, and Japanese.

11. The system of claim 8, wherein the threshold value is 0.80 completion, and each training document is 80% complete.

12. The system of claim 8, wherein the predefined fields are fields of a database record.

13. The system of claim 8, wherein the one or more storage devices store LLM instructions, the LLM instructions being executed by the one or more processors to collectively implement the LLM.

14. The system of claim 13, wherein the one or more processors are configured to parse the target document type by the LLM using reduced system resources, wherein the LLM is configured with parameters modified to use Int8 values.

15. A method for training a specialized large language model (LLM) comprising:
adapting an LLM to operate on a local host;
curating a plurality of résumé documents in a target human language, the plurality of résumés documents meeting or exceeding a completion threshold of at least 0.80 and have been downloaded at least once;
converting the plurality of résumé documents into converted documents having a data interchange format including field/value pairs, the fields being predefined fields and the values being extracted from the plurality of documents;
separating the converted documents into a set of training data and a set of test data, the set of training data being larger than the set of test data, wherein the training data is used to obtain a specialized LLM focused on only parsing résumé documents of the target human language;
adjusting parameters of the LLM based on the training data;
testing the LLM using the set of test data; and
outputting the LLM as the specialized LLM once a testing result of the testing of the LLM exceeds a success threshold, wherein adjusting and testing are repeated until the testing exceeds the success threshold.

16. The method of claim 15, wherein the résumé documents include at least one document selected from a group consisting of: a résumé, and a curricula vitae.

17. The method of claim 15, wherein the target human language is any one human language selected from a group consisting of: English, Spanish, French, German, Chinese, and Japanese.

18. The method of claim 15, wherein the parameters receive values converted from Float32 to Int8.

19. The method of claim 15, wherein the predefined fields are fields of a database record.

20. The method of claim 15, wherein the data interchange format of the converted documents is JavaScript Object Notation (JSON) format.
